(19) United States
(12) Patent Application Publication
(10) Pub. No.: US 2007/0150440 A1
(43) Pub. Date: Jun. 28, 2007

(54) Method and circuit for retrieving data

(75) Inventors: Johannes Henricus Maria Korst, Eindhoven (NL); Robert Jochemsen, Eindhoven (NL); Hong R. Li, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECRONICS, N.V., EINDHOVEN (NL)

(21) Appl. No.: 10/595,751

(22) PCT Filed: Nov. 25, 2004
(86) PCT No.: PCT/IB04/52547

§ 371 Date: May 9, 2006

(30) Foreign Application Priority Data
Dec. 3, 2003 (EP) 03104524.8

(51) Int. Cl. G06F 17/30

(52) U.S. Cl. 707/3

(57) ABSTRACT

Non-contiguous storage of data objects seriously hampers retrieval speed of said data objects (202). Furthermore, when multiple data objects are retrieved of which some are fragmented, retrieval time of all data objects gets less predictable. Therefore, it is desirable to retrieve non-fragmented data objects only. For certain cases, this is possible, as not necessarily one specific data object has to be retrieved. In such cases, retrieval of a similar data object, render of the same type, is sufficient. To this, the invention provides among others a method and circuit (124) for retrieval of data. The invention is especially suitable for retrieving audiovisual data for trickplay. When a first frame selected for rendering is stored fragmented, a second, not fragmented frame is selected and retrieved instead of the first frame.

The invention relates to a method of retrieving data objects stored in a storage device organised in allocation units. The invention further relates to a circuit for retrieving data objects stored in a storage device organised in allocation units.

The invention yet further relates to an apparatus for rendering of audiovisual data comprising a circuit for retrieving data objects stored in a storage device organised in allocation units.

The invention also relates to a computer programme product for programming a processing unit to execute a method of retrieving data objects stored in a storage device organised in allocation units.

The invention relates to a record carrier for storing such computer programme product.

The invention yet further relates to a programmed computer enabled to execute a method of retrieving data objects stored in a storage device organised in allocation units.

Data stored in a memory is preferably stored contiguously. In this way, it can be retrieved in one reading action by a reading unit. However, due to deletion of files and storage of further data objects like data files and streams of audio-visual data, relatively small gaps between data objects occur. This is free space, but usually not enough space to store a full data object. To benefit from the free space nevertheless, the data object has to be stored in fragments. This is disadvantageous. Reason for this is that during retrieval, the reading unit has to switch from fragment to fragment During this switch, no data can be read. For retrieval of data objects like executable computer programmes and text files, this is not necessarily problematic, as flawless retrieval of such data objects is usually more important than the actual retrieval speed.

On the other hand, when retrieving audio-visual data like a video stream, timely delivery is important. Video data is usually compressed prior to storage. The most frequently used compression algorithms like MPEG-2 are based on predictive compression, meaning that for decompression of at least some of the video frames, data of multiple (uncompressed) other frames is needed. When this data is not provided in time, problems occur in rendering of the audio-visual data; hiccups in the video may occur, or even screen blackouts. For a consumer, watching a film, this is very annoying.

Increased retrieval time caused by fragmentation of data objects can be taken into account when scheduling data retrieval requests, but this is rather difficult. This is especially the case with fast trickplay playback, where only a relatively small number of frames are retrieved (trickplay playback is non-realtime playback, like fast and slow forward/backward). A large increase in retrieval time of one object may seriously disturb real-time performance of a system, when not taken into account with scheduling.

This problem occurs for example with video data stored on a harddisk drive, where fragmentation of data objects is a well-known issue, but also with optical drives, as re-writable optical drives with possibilities of deleting and storing individual files like the DVD+RW are rapidly gaining ground in the consumer electronics world.

U.S. Pat. No. 5,842,046 proposed a method to store I-frames unfragmented in separate allocation units to facilitate data retrieval for trickplay. However, as I-frames vary in size, always free storage space will be left in the allocation units, resulting in a waste of storage space.

Therefore, it is an object of the invention to provide a method that decreases the disadvantageous effects of fragmentation of data objects on the data retrieval of those data objects. This object is achieved according to the invention with a method comprising the steps of: selecting multiple pre-determined data objects of a particular type for retrieval; determining whether a selected first data object is stored fragmented over multiple allocation units; if the selected first data object is stored fragmented over multiple allocation units: selecting a second data object of the particular type stored close to the selected first data object, the second data object not being stored fragmented over multiple allocation units; and unselecting the selected first data object; and retrieving the selected data objects.

When a sequence of selected data objects has to be retrieved, wherein all data objects are of a specific type, cases are imaginable wherein it does not matter whether one specific selected data object has to be retrieved. It may just as well be another data object of the specific type, close to the selected data object. This has for example also been proposed by unpublished application EP-03100973.1, applicant reference PHNL030361, providing a solution to a different problem. Reasoning from this starting point, it would—from the selection point of view—hardly make a difference whether a firstly selected, fragmented data object is retrieved or a secondly selected, but unfragmented data object is retrieved, the secondly selected data object being close to the firstly selected data object in the sequence. However, from a data retrieval point of view, it does make a big difference, as the retrieval of the secondly selected, unfragmented data object will take far less time than retrieval of the firstly selected, fragmented data object. Therefore, the method according to the invention provides a major advantage.

In an embodiment of the invention, the data objects are stored in a sequence and the second data object is selected from a group of data objects between and including: a selected third data object, wherein the selected third data object is the closest selected data object prior to the selected first data object; and the selected first data object.

The second data object can either be selected prior to or after the selected first data object, for the general case, there is no big difference. However, when data objects of the particular type located after the selected first data object deviate more from the selected first data object than the data objects of the particular type located prior to the selected first data object, it is desirable to select second data object prior to the selected first data object. In this way, the most representative trickplay stream is provided to a viewer.

In a further embodiment, based on the previously described embodiment, the second data object is the selected third data object.

This embodiment of the method according to the invention is an even further decrease in the time needed for retrieval. However, when using the invention for retrieval of a stream of audio-visual data for rendering and display, this does bring the disadvantage of introducing some jitter in the display of the trickplay stream. On the other hand, for higher trickplay speeds, this is no problem. Furthermore, when the size of the allocation units is substantially higher than the size of the data objects to retrieve, the probability of a selected data object being fragmented is rather low.

The circuit according to the invention comprises a processing unit conceived to: select multiple pre-determined data objects of a particular type for retrieval; determine whether a selected first data object is stored fragmented over multiple allocation units; if the selected first data object is stored fragmented over multiple allocation units: select a second data object of the particular type stored close prior to or after the first selected data object, the second data object not being stored fragmented over multiple allocation units; and unselect the selected first data object; and retrieve the selected data objects.

The apparatus according to the invention comprises a memory for storing audiovisual data, the circuit according to claim 9 for retrieving audiovisual data from the memory and means for rendering the retrieved audiovisual data.

The computer programme product according to the invention is conceived to programme a processing unit to execute the method according to claim 1.

The record carrier according to the invention carries the computer programme product according to claim 11.

The programmed computer according to the invention is enabled to execute the method according to claim 1

Embodiments of the invention will now be described in more detail by means of Figures, wherein:

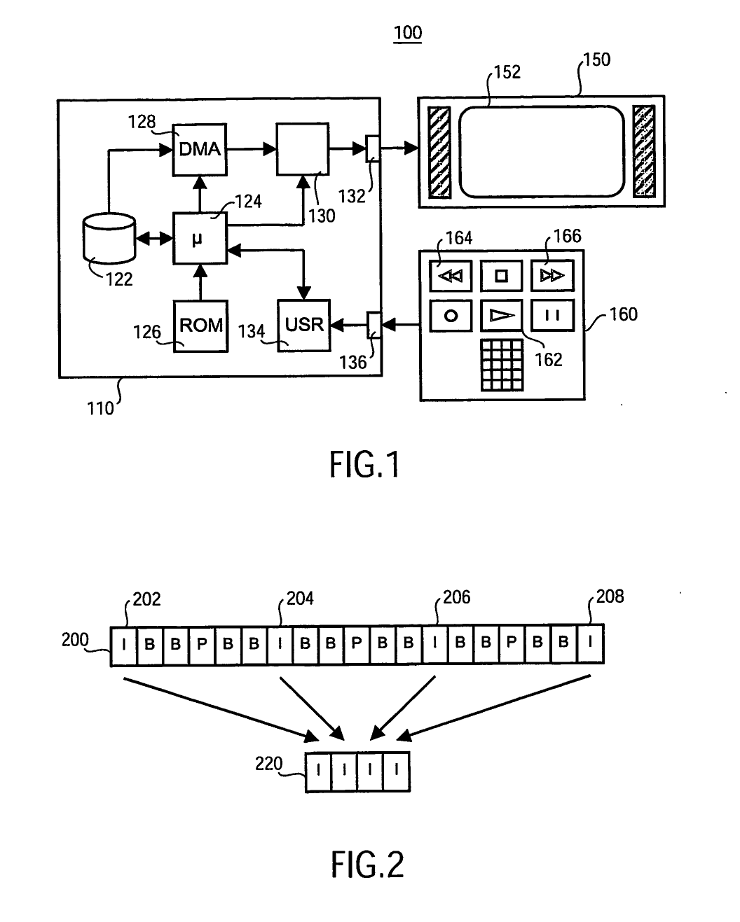

FIG. 1 shows a flowchart an apparatus comprising an embodiment of the circuit according to the invention;

FIG. 2 shows a stream of audio-visual data and a stream of selected frames;

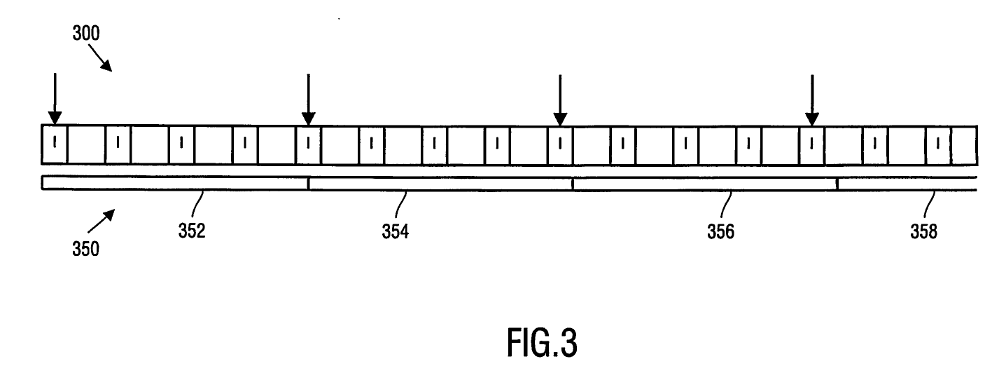

FIG. 3 shows a further stream of audio-visual data and a schematic representation of a storage medium divided in allocation units; and

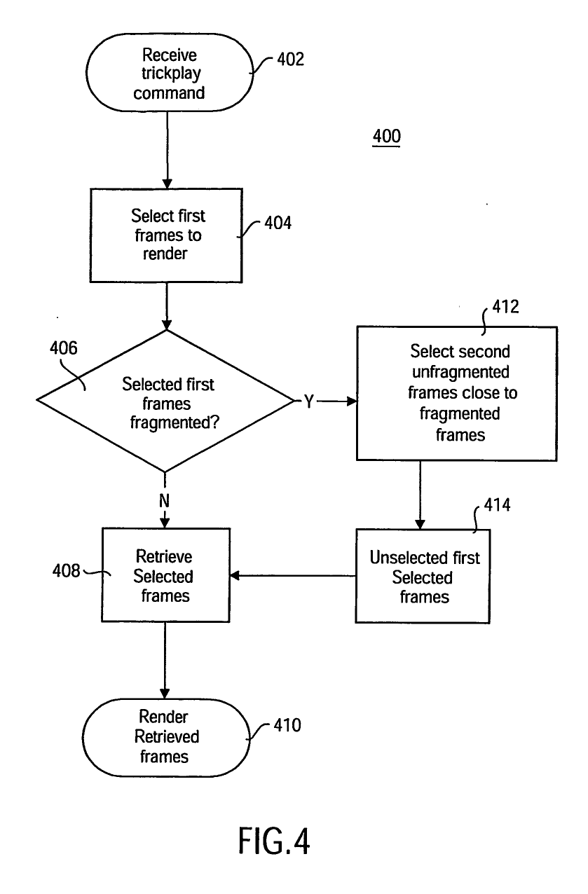

FIG. 4 shows depicting an embodiment of the method according to the invention.

FIG. 1 shows a consumer entertainment system 100 comprising a consumer electronics apparatus 110 as an embodiment of the apparatus according to the invention, a user control device 160 and a TV set 150.

The apparatus 110 comprises a storage device, preferably a harddisk drive 122 for storing audiovisual data, a processing unit 124 for controlling the apparatus, a Read Only Memory (ROM) 126 as an embodiment of the record carrier according to the invention for storing programme data for programming the processing unit 124, a DMA controller 128 for rapid data transfer from the harddisk drive 122 to a video rendering unit 130, comprised by the apparatus as well, and a user command controller 134 for receiving user commands. The ROM 126 can be implemented in various ways: solid state ROM, EEPROM, a magnetic data carrier, an optical data carrier or any other carrier. The processing unit 124 and the ROM 126 form an embodiment of the circuit according to the invention.

The TV-set 150 comprises a screen 152. The TV-set is connected to the consumer electronics apparatus 110 by means of a first connector 132.

The user control device 160 comprises a play button 162, a rewind button 164 and a fast forward button 166 for controlling the direction and speed of playback of a stream of audiovisual data by the consumer electronics apparatus 110. The user control device 160 is connected to the consumer electronics apparatus 110 by means of a second connector 136. The connection may be either wired or wireless, this is irrelevant for the operation of the invention.

The consumer electronics apparatus 110 is intended for playback of streams of audiovisual data, stored in the harddisk drive 122. In another embodiment, this may just as well be an optical disk. The playback is initiated by a user command, for example pressing the play button 162. This generates a control signal in the user control device 160, received by the user command controller 134 and transmitted to the processing unit 124.

On reception of the control signal, the processing unit 124, programmed by a programme in the ROM 126, initiates retrieval of audiovisual data from the harddisk drive 122 and arranges transfer of the retrieved data to the video rendering unit 130 via the DMA controller 128. The video rendering unit 130 decodes the audiovisual data, which is in this embodiment compressed according to the MPEG (Motion Pictures Expert Group) 2 standard. The output of the video rendering unit is a video signal according to a known format (e.g. SECAM or PAL), presentable on the TV-set 150. The video signal is provided via the first connector 132.

FIG. 2 shows a stream 200 of compressed video data, compressed according to the MPEG 2 standard. The stream 200 is built up from compressed frames of three different types. They are grouped in a so-called Group Of Pictures or GOP. For this example, a GOP-size of six is taken, but the person skilled in the art will appreciate that also other GOP-sizes are allowed.

The ‘I’ frames are intracoded, which means that they can be decompressed using the proper decompression algorithm and data from the frame itself. The ‘B’ and ‘P’ frames are interceded, which means that data from other (decoded) frames is needed as well to decompress those frames. For the decoding of compressed P-frames, data from the directly preceding I-frame or P-frame is needed. For the decompression of B-frames, data from a preceding and/or succeeding I-frame or P-frame is needed.

Showing all pictures during normal real-time playback of the data renders a fluent video film on the display 152 (FIG. 1) of the TV-set 150 (FIG. 1), as all decoding as described in the previous paragraph can be done real-time. In case of fast playback of the video data, for example when a user presses the rewind button 164 or the fast forward button 166 during real-time playback, decoding all frames in synchronisation with the fast playback is not possible anymore. This is also not necessary, as in such a case more frames would be rendered than can be processed by the human eye and brain.

Therefore, usually only I-frames are rendered. For the stream 200 this would mean that for fast playback, a first I-frame 202, a second I-frame 204, a third I-frame 206 and a fourth I-frame 208 are combined to a trickplay stream 220. Playback of the trickplay stream 220 at the same frame rate of the stream 200 would result in a speed increase of a factor six. When all frames would be displayed three times longer, this would result in a speed increase of a factor two.

For higher rendering speeds, for example 12 times real time, rendering of some I-frames can be skipped an only a selected number of I-frames can be rendered. This is illustrated in FIG. 3, showing a stream 300. The stream 300 is compressed using the MPEG 2 standard. For the sake of simplicity, only the I-frames are indicated; the GOP-size is 6 (one I-frame with one P-frame and four B-frames after each I-frame). Since the GOP-size is 6 and every GOP has one I-frame, every second I-frame, indicated by arrows in FIG. 3, has to be rendered, wherein each frame is shown as long as during normal playback speed, the speed up factor of playback is 12.

Harddisk drives like the harddisk drive 122 are organised in allocation units. For consumer electronics applications like video storage, the allocation units are relatively large. It is important to understand that an allocation unit is not the same as a sector. With respect to video storage, they are at least substantially (a factor of ten at least) larger than the size of an I-frame. Nevertheless, data for one I-frame may be stored in such a way that it is fragmented over two non-contiguous allocation units. This means that retrieval of such an I-frame takes up to twice the amount of time needed to retrieve an unfragmented I-frame.

The actual additional amount of time depends on the seek distance between the two allocation units and the rotational delay. The reason for this is that during one disk request, data of only one contiguous block of at least one allocation unit can be retrieved. When a fragmented data object like an I-frame distributed over two non-contiguous allocation units has to be retrieved by order of a (one) file request, two disk requests have to be issued and executed. The translation from file requests to disk requests is done by the file system, which is part of the host software stack.

The bar 350 is a schematic representation of a part of the harddisk drive 122 and is divided in a first allocation unit 352, a second allocation unit 354, a third allocation unit 356 and a fourth allocation unit 358. Although the size of one allocation unit is larger than the size of one I-frame, it is still possible that one I-frame is stored in fragments over two allocation units. Furthermore, although the allocation units are drawn contiguously, they do not necessarily have to be located contiguously on the disk.

When the allocation units are not located contiguously on the disk, this carries the problem that for retrieval of one I-frame, data from two allocation units has to be retrieved. This means that for one file request, two disk requests have to be executed; with one disk request, data of at most one allocation unit can be retrieved. This increases the retrieval time of a fragmented I-frame, compared to data retrieval of an unfragmented I-frame.

For playback of audiovisual data, it is important that data is retrieved in time from the harddisk drive 122 (FIG. 1) and rendered in time by the video rendering unit 130 (FIG. 1). Furthermore, when the harddisk drive is used by more than one application, data should be retrieved efficiently, limiting the number of disk requests.

For trickplay of a video stream (rendering a video stream at non-real-time speeds, either faster or slower) at real fast speeds, say above a speed up factor of 10 compared to real-time play of the video stream, it is irrelevant whether I-frames are selected strictly periodically. For the example as depicted in FIG. 3, this would mean that it would make hardly a difference whether the third or fifth I-frame would be selected for rendering instead of the fourth I-frame and whether the seventh or ninth I-frame would be selected for rendering instead of the eight I-frame.

For the reasons mentioned above, using an embodiment of the method according to the invention, fast replay of the stream 300 would result in retrieval and rendering of the first, the fifth, the eighth and the twelfth I-frame using a method depicted by a flowchart 400 shown by FIG. 4. By retrieving the fifth I-frame instead of the fourth I-frame for rendering, one disk request less is needed and so, less time is needed for retrieval of data for fast playback of the stream 300.

The embodiment of the method according to the invention just discussed will be described in more detail by means of the flowchart 400. The flowchart 400 starts with a startpoint 402, wherein a trickplay command is received. Next, in a process 404, first frames are selected for retrieval and rendering. Which frames are selected depends mainly on the trickplay speed selected by a user. For a fast trickplay speed, less frames are selected at a larger distance from each other than for trickplay at a lower speed. For the example depicted in FIG. 3, every fourth frame is selected.
Next, in a decision 406, is checked whether any of the selected first frames are stored in fragments, i.e. distributed over multiple non-contiguous allocation units. This can be done in various ways:
File systems in general keep a list of disk locations where the file data is stored. So for any data object like a piece of a file to be retrieved (e.g. start offset in bytes, and length in bytes) the locations can be found. A data object is stored fragmented when not all disk locations for this data object are contiguous. This way, finding out whether a certain data object is fragmented is trivial.
Video applications can keep a list that describes video segments like I-frames and their position within the file (or video stream), e.g. a CPI (Characteristic Point of Information) file with for each I-frame a start offset in bytes, and length in bytes. It is therefore very simple to find the piece of file to be retrieved for a given I-frame. Combining above two methods directly yields whether the retrieval of an I-frame is fragmented or not.
A data object like an I-frame is stored in a -linked list of allocation units. Two successive allocation units to which the data object is assigned may be contiguous or they may be non-contiguous. The points where data is stored non-contiguous can be kept in a list, expressed as distances from the start of the file (in bits or Mbits). In addition, the start and length of each of the I-frames can also be stored in a list, where the start can also be expressed as distances from the start of the file (in bits and Mbits) and the lengths correspondingly in bits or Mbits. When combining both lists one can easily determine which of the I-frames are stored contiguously, by scanning through both lists in parallel.
Let p_{—}1, p_{—}2, p_{—}3, . . . , p_n denote the positions in the file where data is stored non-contiguously. Let (s_{—}1,1_{—}1), (s_{—}2,1_{—}2), (s_{—}3,1_{—}3), . . . , (s_m,l_m) be the list of start positions and lengths of the successive I-frames. Then, we can scan through the second list until we find a j such that 1. s_j<p_{—}1<s_j+1_j or 2. s_j+1_j<p_{—}1<s_(j+1).
In the first case, we have that the first non-contiguity in the file fragments an I-frame, namely the j-th I-frame to be precise. In the second case, it does not fragment an I-frame. This procedure can be continued to check all non-contiguities.

When at least one selected I-frame is fragmented, second I-frames are selected in a process step 412, close to the first frames that are fragmented. This may either be the I-frame directly prior to or after the fragmented I-frame, but also the second I-frame prior to or after the fragmented I-frame from the group of first I-frames. This means that “close to” is defined either as temporally close (in the sense of playback time) or logically close (in the sense of distance in bits). It does not necessarily mean spatially close, on a disk platter.

In an advantageous embodiment, a selected first I-frame directly prior to or directly after the fragmented I-frame is selected. In other words, the I-frame displayed last is displayed again, replacing display of the fragmented I-frame. An advantage of this embodiment is that even two disk requests are saved. In a further embodiment, the selected I-frame directly after the fragmented I-frame is displayed, replacing display of the fragmented I-frame.

After second I-frames are selected in a step 412, fragmented first I-frames are de-selected in a step 414. Next, the process continues to a step 408, in which selected—first and second—I-frames are retrieved for rendering. When in the decision 406 is detected that none of the selected I-frames is stored fragmented, the process continues directly to the step 408. Finally, in a final step 410, the retrieved I-frames are rendered for presentation on the screen 152 (FIG. 1) of the TV-set 150 (FIG. 1).

Although embodiments of the invention have all been described by means of a harddisk on which a video stream compressed according to the MEPG-2 standard is stored, the invention is also applicable in other situations. Examples for this are other video storage standards like MPEG-4 and DV. Various variations are possible without departing from the scope of the invention. The harddisk drive can be replaced by an optical or magneto-optical disk or even a solid-state memory. Also, other compression algorithms can be used. Furthermore, the data to be retrieved can also be other than video data. An example for this is the case where audio bursts are to be retrieved from a Super Audio Compact Disc for fast trickplay.

Embodiments of the invention have been described by retrieving I-frames only during trickplay. However, P-frames can be retrieved as well, having decoded the preceding I-frame or P-frame as this frame is needed for decoding a P-frame. In theory, this means that B-frames can be retrieved as well, but in fast trickplay mode, probably too much processing power would be necessary and too much other frames would have to be retrieved and decoded, rendering this embodiment inefficient So although according to the invention frames of a ‘particular type’ are to be retrieved, the ‘particular type’ is not limited to I-frames when applying the invention to retrieval of MPEG2 encoded data for fast trickplay.

Also, this invention can be used when retrieving selected portions of non audio-visual data, although real-time requirements are usually more relaxed for this kind of cases. When a selection is made from a sequence of measurement values for determining for example the average, median or standard deviation and the fluctuations from selected portion to selected portion are not too high, the invention can be used as well.

Furthermore, various tasks being described as being performed by single processing unit, may just as well be carried out by multiple modules in other embodiment of the invention, without departing from the scope of the invention. On the other hand, also tasks as being described to be performed by multiple modules may just as well be combined in one processing module.

The invention can be summarised as follows: Non-contiguous storage of data objects seriously hampers retrieval speed of said data objects. Furthermore, when multiple data objects are retrieved of which some are fragmented, retrieval time of all data objects gets less predictable. Therefore, it is desirable to retrieve non-fragmented data objects only. For certain cases, this is possible, as not necessarily one specific data object has to be retrieved. In such cases, retrieval of a similar data object, of the same type, is sufficient. To this, the invention provides among others a method and circuit for retrieval of data. The invention is especially suitable for retrieving audiovisual data for trickplay. When a first frame selected for rendering is stored fragmented, a second, not fragmented frame is selected and retrieved instead of the first frame.

1. Method of retrieving data objects (202, 204, 206, 208) stored in a storage device (122) organised in allocation units (352, 354, 356,358), the method comprising the steps:
a) selecting multiple predetermined data objects of a particular type for retrieval;
b) determining whether a selected first data object is stored fragmented over multiple allocation units;
c) if the selected first data object is stored fragmented over multiple allocation units:
i.) selecting a second data object of the particular type stored close to the selected first data object, the second data object not being stored fragmented over multiple allocation units; and
ii.) unselecting the selected first data object; and
d) retrieving the selected data objects.

2. Method according to claim 1, wherein the data objects are stored in a sequence and second data object is selected from a group of data objects between and including:
a) a selected third data object, wherein the selected third data object is the closest selected data object in the sequence prior to the selected first data object; and
b) the selected first data object.

3. Method according to claim 2, wherein the second data object is the selected third data object.

4. Method according to claim 1, wherein the data objects are stored in a sequence and the second data object is selected from a group of data objects between and including:
a) a selected fourth data object, wherein the selected fourth data object is the closest selected data object in the sequence after the selected first data object; and
b) the selected first data object.

5. Method according to claim 4, wherein the second data object is the selected fourth data object.

6. Method according to claim 1, wherein the data objects are frames comprised by a video stream (200).

7. Method according to claim 6, wherein stream is coded and comprises intra-coded and inter-coded frames and the data objects of the particular type are intra-coded frames.

8. Method according to claim 1, wherein the storage device is a disk based medium.

9. Circuit (124) for retrieving data objects (202, 204, 206, 208) stored in a storage device (122) organised in allocation units (352, 354, 356, 358), the circuit comprising a processing unit (124) conceived to
a) select multiple pre-determined data objects of a particular type for retrieval;
b) determine whether a selected first data object is stored fragmented over multiple allocation units;
c) if the selected first data object is stored fragmented over multiple allocation units:
i.) select a second data object of the particular type stored close prior to or after the first selected data object, the second data object not being stored fragmented over multiple allocation units; and
ii.) unselect the selected first data object; and
d) retrieve the selected data objects.

10. Apparatus (110) for rendering of audiovisual data, comprising a memory for storing audiovisual data, the circuit according to claim 9 for retrieving audiovisual data from the memory and means for rendering the retrieved audiovisual data.

11. Computer programme product (126) for programming a processing unit to execute the method according to claim 1.

12. Record carrier (126) carrying the computer programme product according to claim 11.

13. Programmed computer enabled to execute the method according to claim 1.
